(19) United States
(12) Patent Application Publication
(10) Pub. No.: US 2008/0148395 A1
(43) Pub. Date: Jun. 19, 2008

(54) System and method for securing settings of a computing device

(76) Inventor: Chris Brock, Manorville, NY (US)

Correspondence Address: FAY KAPLUN & MARCIN, LLP, 150 BROADWAY, SUITE 702, NEW YORK, NY, 10038, US

(21) Appl. No.: 11/585,635

(22) Filed: Oct. 24, 2006

(51) Int. Cl. H04L 9/32

(52) U.S. Cl. 726/21

(57) ABSTRACT

Described is a system and method for securing settings of a computing device. A data capture device comprises a memory storing a first parameter for a setting, an input arrangement receiving first authentication data from a user of the scanner and a processor comparing the first authentication data to stored data to authenticate the user. The stored data includes second authentication data corresponding to at least one user authorized to reconfigure the setting. If the user is authenticated, the processor adjusts the setting with a second parameter received from the user.

### FIELD OF INVENTION

The present invention generally relates to systems and methods for securing settings of a computing device. In particular, the present invention relates to securing settings of a data capture device such as, for example, a barcode scanner and/or a radio frequency identification (RFID) reader.

### BACKGROUND

Generally, settings for a conventional computing device are initially configured by a manufacturer. This allows the computing device to be used out-of-the-box without requiring manual configuration prior to use. However, the settings are typically customizable and reconfigurable based on, for example, user preferences, operating environments, intended uses, etc.

Typically, there is no restriction on reconfiguring the settings. Thus, an employee may reconfigure the settings based on personal preference, even though an employer may desire the computing device to predefined settings. For example, the employee may adjust a brightness level of a display screen of the computing device to a maximum level. While this is a departure from the predefined settings, this setting may also unnecessarily waste power available to the computing device. In addition, a subsequent user of the computing device may waste time reconfiguring the settings based on his personal preferences. Thus, there is a need to restrict access to the settings of the computing device.

### SUMMARY OF THE INVENTION

The present invention relates to a system and method for securing settings of a computing device. A barcode scanner comprises a memory storing a first parameter for a setting, an input arrangement receiving first authentication data from a user of the scanner and a processor comparing the first authentication data to stored data to authenticate the user. The stored data includes second authentication data corresponding to at least one user authorized to reconfigure the setting. If the user is authenticated, the processor adjusts the setting with a second parameter received from the user.

### BRIEF DESCRIPTION OF THE DRAWINGS

FIG. 1 shows an exemplary embodiment of a system according to the present invention.

FIG. 2 shows an exemplary embodiment of a method according to the present invention.

### DETAILED DESCRIPTION

The present invention may be further understood with reference to the following description and the attached drawings, wherein like elements are referred to with the same reference numerals. The exemplary embodiments of the present invention describe a system and method for securing settings of a computing device. Although the exemplary embodiments will be described with reference to a mobile computing device and, in particular, a barcode scanner, those of skill in the art will understand that the systems and methods for securing settings may be similarly implemented on stationary computing devices such as, for example, PCs, copiers, fax machines, sound systems, display screens, smart appliances, etc.

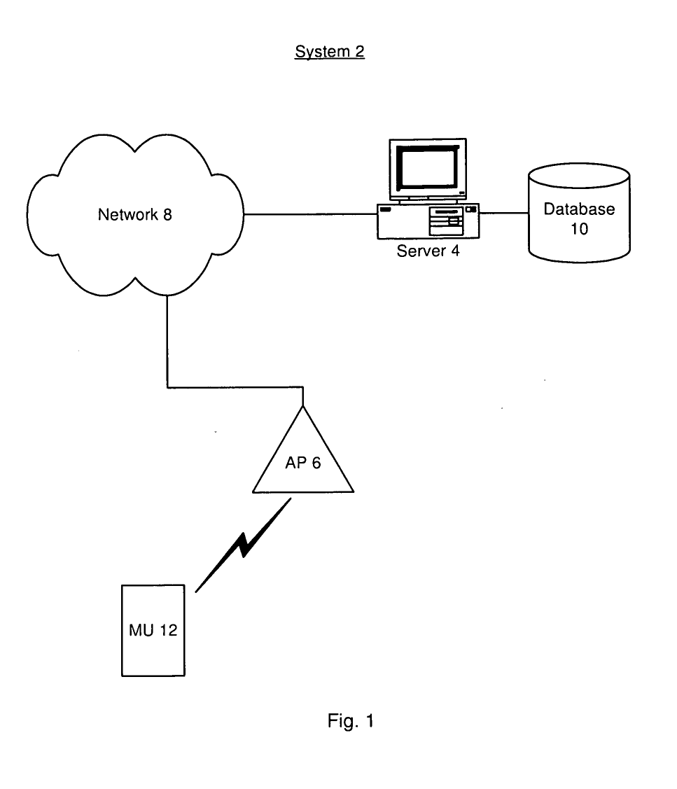

FIG. 1 shows an exemplary embodiment of a system 2 for securing settings on a computing device according to the present invention. The system 2 may comprise components typically utilized in a wired/wireless local area network (LAN). For example, the system 2 may include a server 4 that is coupled to a wireless access point (AP) 6 via a communications network 8. The network 8 may comprise one or more network computing devices (e.g., routers, bridges, repeaters, etc.) which are part of and/or connected to other communications networks (e.g., further LANs, an intranet, a wide area network, the Internet). The server 4 may also have access to a database 10 which may be used in an authentication procedure, as will be described further below.

The AP 6 provides wireless access to the server 4 and the network 8 for a mobile computing unit (MU) 12. The MU 12 may be a processor-based computing device which includes a memory and a wireless transceiver for conducting wireless communications with the AP 6 (e.g., according to an IEEE 802.11 protocol). The MU 12 may be an imager-/laser-based scanner, an RFID reader, a mobile phone, a PDA, a laptop, a tablet computer, a digital camera, a portable media player, a handheld computer, etc.

The memory of the MU 12 stores setting data corresponding to at least one setting of the MU 12. The settings may include, for example, barcode symbologies recognized by the MU 12, a date/time, a display characteristic (e.g., volume, LCD brightness), a power-save mode time, a scan session time, wireless communications, etc. Those of skill in the art will understand that the present invention may be similarly implemented for any other setting utilized by the MU 12. The setting data may further include a parameter which corresponds to each of the settings and is used for current operation of the MU 12. For example, the setting for the LCD brightness may include a parameter indicative of a brightness level.

In the exemplary embodiment, access to the setting data is restricted by a security mechanism (e.g., password, biometric, location-based, MU identifier, etc.). That is, the security mechanism may prevent an unauthorized user from reconfiguring a setting with a new parameter. In one exemplary use, an employer may implement the security mechanism to ensure that employees do not reconfigure the setting data. For example, the setting data may be configured with a parameter(s) indicating that the MU 12 should only recognize proprietary barcodes utilized in the employer's store. If the setting data was reconfigured to recognize standard barcodes (e.g., UPC, EAN), the MU 12 may improperly recognize or decode the proprietary barcodes.

In another exemplary use, the setting data may be configured with a parameter(s) indicative of a current date and time. In this manner, the MU 12 may be used for age verification procedures during the purchase of tobacco, alcohol, firearms, video games, movies, magazines, etc. Allowing an employee to reconfigure the current date and time may enable underage persons to obtain these items.

In a further exemplary use, the setting data may be configured with a parameter(s) indicative of one or more display characteristics. That is, the employer may determine parameters for LCD brightness and volume which are sufficient for the employees to conduct their assigned tasks in known environments (e.g., retail store, warehouse, shipping yard, etc.). Using these parameters, the MU 12 will not have to be recharged during the tasks. In addition, the MU 12 will operate uniformly between uses and users. Allowing the employees to alter the setting(s) for the display characteristic(s) may unnecessarily waste battery power of the MU 12 and time for subsequent users of the MU 12.

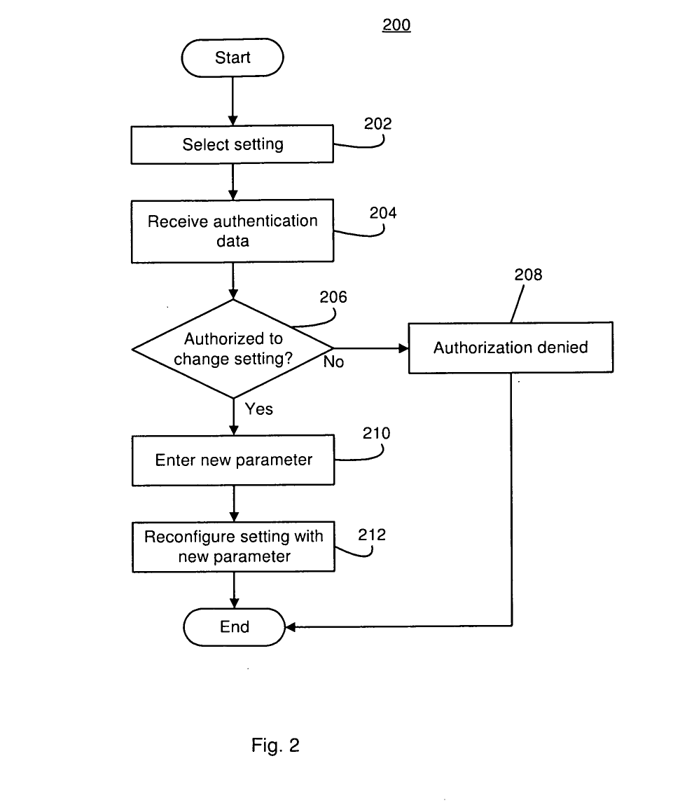

FIG. 2 shows an exemplary embodiment of a method 200 for securing settings on a computing device according to the present invention. The method 200 describes a process for authenticating a user, and determining whether the user is authorized to enter a new parameter for reconfiguring a setting of the MU 12. While the exemplary embodiment will be described with reference to the server 4 executing the authentication procedure, those of skill in the art will understand that the authentication procedure may be similarly implemented by the MU 12. That is, the MU 12 may execute the full authentication process without communicating with the network 8 or the server 4. In this embodiment, the MU 12 may not include the wireless transceiver.

In step 202, a setting is selected by the MU 12 in response to a user indication, e.g., a selection of the setting via a user interface (e.g., touch screen/pad, keypad, etc.) of the MU 12. The processor of the MU 12 may interpret the selection and select the corresponding setting. A parameter associated with the setting may be displayed on a display screen of the MU 12.

In step 204, the MU 12 receives authentication data from the user. That is, if the user attempts to change the parameter for the setting, the MU 12 may prompt the user for the authentication data. The authentication data may be, for example, a password, a PIN code, a biometric identifier (e.g., retina scan, fingerprint, voice), a handwriting sample (e.g., a signature), etc. and received via an input arrangement (e.g., a keypad, a laser-based scanner, an image capture device, a biometric reader, a touch screen and a touch pad). Those of skill in the art will understand that the user interface of the MU 12 or a peripheral device (e.g., a barcode scanner) coupled thereto or integral therewith may be utilized to receive the authentication data. For example, the scanner may scan a barcode on the user's identification badge and/or may scan barcodes associated with commands and/or alphanumeric characters. In the latter case, the scanner may scan a command barcode for entering a password, then scan letter/number barcodes and finally scan an input barcode so that the password is assembled by the MU 12 to complete the authentication data.

In step 206, the MU 12 transmits the authentication data to the server 4, and the server 4 compares the authentication data to stored data in the database 10. The stored data may be input by an administrator and correspond to authentication data of users authorized to adjust the setting(s) of the MU 12. Alternatively, the stored data may correspond to an initial password stored on the MU 12 or input by the user upon a first use of the MU 12. In one exemplary embodiment, the authentication data may authorize the user to change a plurality of settings on the MU 12. That is, one password may allow the user to change any or selected ones of the settings on the MU 12. In another exemplary embodiment, a separate password may be required to change each of the settings. For example, the user may be given a password to change the parameters for the display characteristics of the MU 12, but not the date/time parameter.

In the exemplary embodiment, the server 4 compares the authentication data to the stored data and generates result data indicating whether the user is authorized to change the parameter for the setting. As noted above, the authentication procedure may be performed locally by the MU 12. In this instance, the stored data may be stored in the memory of the MU 12. The store data may be updated periodically by, for example, downloading the stored data from the server 4 and replacing it in the memory of the MU 12. In this manner, the administrator may authorize users to change the settings from a remote location.

In step 208, the result data indicates that the authentication data does not match the stored data. The result data is transmitted to the MU 12, and the MU 12 disallows the user's request to enter a new parameter for the setting. In step 210, the result data indicates that the authentication data matched the stored data. The result data is transmitted to the MU 12, and the user is allowed to enter a new parameter for the setting. In step 212, the MU 12 reconfigures the setting with the new parameter.

In another exemplary embodiment, the result data may include a limit on the new parameter. For example, the limit may indicate that the new parameter for the LCD brightness must be within a predefined range. The MU 12 may deny the change if the new parameter is outside of the limit. Alternatively, the result data may include a predetermined list of parameters from which the user may choose.

In a further exemplary embodiment, the server 4 may utilize an override after determining whether the user is authorized to change the setting. For example, a comparison of the authentication data to the stored data may indicate that the user is not authorized to change the setting. However, based on a location of the MU 12, a time of use, etc., the result data may be overridden to indicate that the user is authorized to change the setting or may impose a less stringent limit on the new parameter. Alternatively, the override may be implemented as an expanded limit/range for the new parameter. An exemplary scenario in which the location may be utilized is when the MU 12 is being used in a shipping yard. The user may be unauthorized to change the LCD brightness. However, because the MU 12 is being used in the shipping yard, the server 8 may authorize the user to change the setting. Thus, on an overnight shift, the user may adjust the LCD brightness.

The present invention has been described with the reference to the above exemplary embodiments. However, those of skill in the art will understand that various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A data capture device, comprising:
a memory storing a first parameter for a setting;
an input arrangement receiving first authentication data from a user of the scanner; and
a processor comparing the first authentication data to stored data to authenticate the user, the stored data including second authentication data corresponding to at least one user authorized to reconfigure the setting,
wherein, if the user is authenticated, the processor adjusts the setting with a second parameter received from the user.

2. The device according to claim 1, wherein the device includes at least one of a barcode scanner and an RFID reader.

3. The device according to claim 1, wherein the setting is one of (i) a recognized barcode symbology, (ii) a date, (iii) a time, (iv) a display characteristic, (v) a power-save mode duration, (vi) a scan session time and (vii) a wireless communication mode.

4. The device according to claim 3, wherein the display characteristics is one of (i) an output volume and (ii) a display screen brightness.

5. The device according to claim 1, wherein the input arrangement includes at least one of (i) a keypad, (ii) a laser-based scanner, (iii) an image capture device, (iv) a biometric reader, (v) a touch screen and (vi) a touch pad.

6. The device according to claim 5, wherein the biometric reader is one of a retinal scanner, a fingerprint reader, a voice recognition device and a signature capture device.

7. The device according to claim 1, wherein the first authentication data includes at least one of a password, a username, a biometric, a location of the device and a device identifier of the device.

8. The device according to claim 1, wherein at least one of the password and the username is entered into the device by one of (i) scanning barcodes associated with characters and commands and (ii) transferring the password and the username from a computing device to the device.

9. The device according to claim 8, wherein the barcodes represent at least one of alphanumeric characters and binary data.

10. The device according to claim 1, wherein the stored data is stored in the memory.

11. The device according to claim 1, wherein the stored data is associated with a predefined range, and the processor determines whether the second parameter is within the predefined range prior to adjusting the setting.

12. The device according to claim 1, wherein, when the user is not authenticated, the processor authenticates the user as a function of at least one of a location of the device and a time of receipt of the first authentication data.

13. A method, comprising:
selecting a setting on a data capture device, the setting being configured with a first parameter;
receiving first authentication data from a user of the device;
comparing the first authentication data to second authentication data, the second authentication data corresponding to at least one user authorized to reconfigure the setting; and
if the user is authenticated, adjusting the setting with a second parameter received from the user.

14. The method according to claim 13, wherein the device includes at least one of a barcode scanner and an RFID reader.

15. The method according to claim 13, wherein the second authentication data is associated with a predefined range.

16. The method according to claim 15, further comprising:
adjusting the setting with the second parameter only if the second parameter is within the predefined range.

17. The method according to claim 13, further comprising:
if the user is not authenticated, authenticating the user as a function of at least one of a location of the device and a time of receipt of the first authentication data.

18. The method according to claim 13, wherein the setting is one of (i) a recognized barcode symbology, (ii) a date, (iii) a time, (iv) a display characteristic, (v) a power-save mode duration, (vi) a scan session time and (vii) a wireless communication mode.

19. The method according to claim 18, wherein the display characteristics is one of (i) an output volume and (ii) a display screen brightness.

20. The method according to claim 13, wherein the input arrangement includes at least one of (i) a keypad, (ii) a laser-based scanner, (iii) an image capture device, (iv) a biometric reader, (v) a touch screen and (vi) a touch pad.

21. The method according to claim 20, wherein the biometric reader is one of a retinal scanner, a fingerprint reader, a voice recognition device and a signature capture device.

22. The method according to claim 13, wherein the second authentication data is stored in a memory of the device.

23. A system, comprising:
a mobile computing device storing a first parameter for a setting, the mobile computing device receiving first authentication data from a user; and
a server comparing the first authentication data to stored data to authenticate the user, the stored data including second authentication data corresponding to at least one user authorized to reconfigure the setting,
wherein, if the user is authenticated, the mobile computing device adjusts the setting with a second parameter received from the user.

24. The system according to claim 23, wherein the mobile computing device is one of an imager-based scanner, a laser-based scanner, an RFID reader, a mobile phone, a PDA, a digital camera, a digital media player, a tablet computer and a laptop.

25. The system according to claim 23, wherein the second authentication data is associated with a predefined range, and wherein the mobile computing device adjusts the settings only if the second parameter is within the predefined range.

26. A barcode scanner, comprising:
a memory means for storing a first parameter for a setting;
an input means for receiving first authentication data from a user of the scanner; and
a processing means comparing the first authentication data to stored data to authenticate the user, the stored data including second authentication data corresponding to at least one user authorized to reconfigure the setting,
wherein, if the user is authenticated, the processing means adjusts the setting with a second parameter received from the user.
